(19) United States
(12) Patent Application Publication
(10) Pub. No.: US 2007/0283334 A1
(43) Pub. Date: Dec. 6, 2007

(54) PROBLEM DETECTION FACILITY USING SYMMETRICAL TRACE DATA

(75) Inventor: Joel L. Masser, San Jose, CA (US)

Correspondence Address: CANTOR COLBURN LLP - IBM TUSCON DIVISION, 55 GRIFFIN ROAD SOUTH, BLOOMFIELD, CT, 06002, US

(73) Assignee: INTERNATIONAL BUSINESS MACHINES CORPORATION, Armonk, NY (US)

(21) Appl. No.: 11/421,809

(22) Filed: Jun. 2, 2006

(51) Int. Cl. G06F 9/45

(52) U.S. Cl. 717/141

(57) ABSTRACT

A method for operating a software processing problem detection facility using symmetrical trace data, the method including examining data in a memory. Then, saving with a timestamp in a cache a saved set of data for resource acquisitions, task suspensions, and processing unit initiations. Then, matching resource releases and saved acquisitions in the saved set of data. Then, deleting matched acquisitions from the saved set of data. Then, matching resumptions and suspensions in the saved set of data. Then, deleting matched suspensions from the saved set of data. Then, matching processing unit terminations and initiations in the saved set of data. Then, deleting matched processing unit initiations from the saved set of data. Then, detecting a processing problem in response to data remaining in the saved set of data.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of Invention

This invention relates in general to software problem detection, and more particularly, to a software processing problem detection facility using symmetrical trace data.

2. Description of Background

Typically, software processing is divided into three parts: (1) acquisition of resources, (2) main processing, and (3) release of resources. Each part poses its own problems but software problems characterized by the failure to release resources are often some of the most difficult to diagnose, for example, the condition known as a memory leak is difficult to diagnose.

Generally, event tracing is used to learn the scenario of the failure. When the problem can be detected shortly after it occurs, this method works well. However, sometimes the amount of time that can be traced is much smaller than the average delay from problem occurrence to problem detection. In such cases, it may be impossible to obtain a trace sufficient to debug the problem, requiring the expenditure of much more effort and time in solving the problem.

An alternative form of processing involves synchronization of multiple tasks. One task may suspend processing or wait until another task has completed a unit of work. Problems in which the suspended task fails to resume are also quite difficult to diagnose. Additional scenarios exist in which units of processing have a traceable initiation and termination, such as initiation of an Input/Output operation and its completion. Such scenarios are also within the scope of this invention and are intended to be included in all references to resource acquisition and release.

Thus, there is a need for a method of a software processing problem detection facility using symmetrical trace data that enables early problem detection.

### SUMMARY OF THE INVENTION

The shortcomings of the prior art are overcome and additional advantages are provided through the provision of a method for operating a software processing problem detection facility using symmetrical trace data, the method comprising: examining data in a memory; saving with a timestamp in a cache a saved set of data for resource acquisitions and task suspensions; matching resource releases and saved acquisitions in the saved set of data; deleting matched acquisitions from the saved set of data; matching resumptions and suspensions in the saved set of data; deleting matched suspensions from the saved set of data; matching processing unit terminations and initiations in the saved set of data; deleting matched processing unit initiations from the saved set of data; and detecting a processing problem in response to data remaining in the saved set of data.

Additional features and advantages are realized through the techniques of the present invention. Other embodiments and aspects of the invention are described in detail herein and are considered a part of the claimed invention. For a better understanding of the invention with advantages and features, refer to the description.

### TECHNICAL EFFECTS

As a result of the summarized invention, technically we have achieved a solution for a method for operating a software processing problem detection facility using symmetrical trace data.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of a process for operating a software processing problem detection facility using symmetrical trace data.

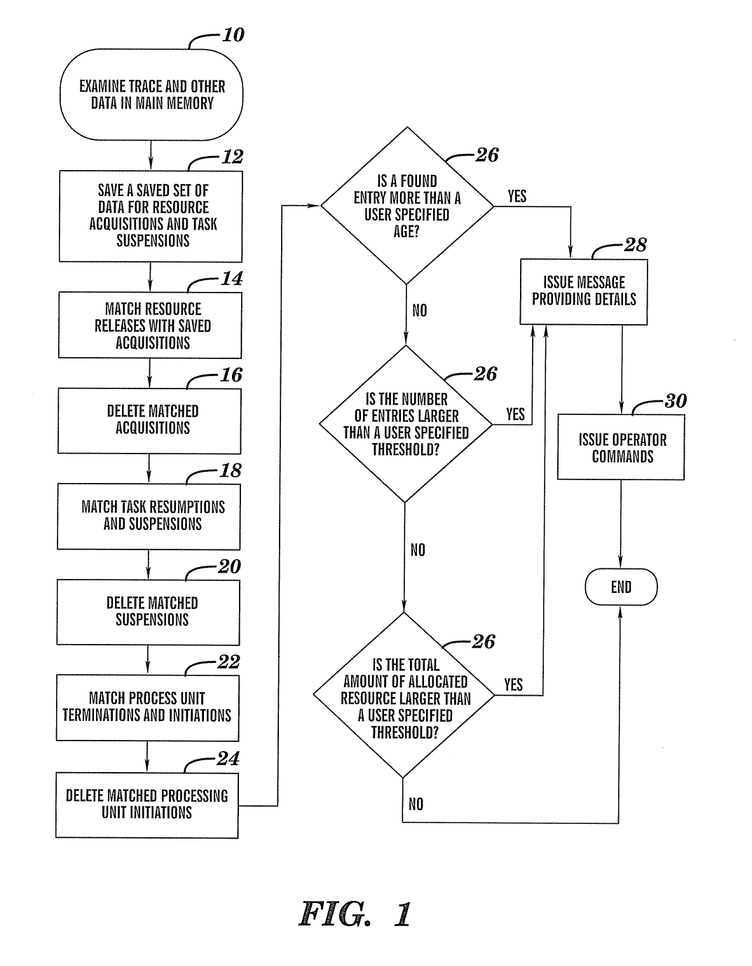

The detailed description explains the preferred embodiments of the invention, together with advantages and features, by way of example with reference to the drawings.

### DETAILED DESCRIPTION OF THE INVENTION

The proposed invention remedies the difficulties previously explained by pairing resource acquisitions with resource releases and/or pairing suspend and resume operations in real time, enabling early problem detection and relieving the constraints on space to hold trace data.

A method for operating a software processing problem detection facility using symmetrical trace data, shall now be explained. At step 10, trace and/or other data in a main memory is examined according to user specified detection control parameters. The parameters specify how to locate the trace data, how to examine the trace data and thresholds for determining that a problem has arisen. The method of the proposed invention can operate on various computer operating systems.

At step 12, saving with a time stamp in a cache a saved set of data for resource acquisitions and task suspensions, occurs. The data in the cache identifies resources and tasks (e.g., by name or other identifier) and indicates the status (acquired, suspended, etc.). The time stamped resource acquisition data and task suspension data is used comparatively and allows the user to analyze and record data transactions in real time. The information is used to detect a software processing problem but the information can also be used for other things such as the production of a histogram, etc.

At step 14, resource releases are matched with saved acquisitions in the saved set of data according to user specified control parameters.

At step 16, matched acquisitions are deleted from the saved set of data. Normal processing consists of first a resource acquisition, followed by its use, and finally its release. An unmatched acquisition represents a resource that is held such that it is unavailable for use by other processes. This invention detects resource shortages. An unmatched release is assumed to match an acquisition that occurred prior to the initiation of the process that performs the problem detection described in this application, and thus is not necessarily considered an indication of a problem. A user parameter would specify whether such an unmatched release should be reported as a detected problem.

At step 18, task resumptions and suspensions in the saved set of data are matched. At step 20, matched suspensions are deleted from the saved set of data. If a task is suspended and then resumed, this corresponds to normal operation and the suspension is considered matched to a resumption and deleted. The unmatched suspensions represent tasks that were suspended and not resumed, thus indicating a problem.

At step 22, processing unit terminations and initiations in the saved set of data are matched. At step 24, matched processing unit initiations from the saved set of data are deleted.

At step 26, a processing problem is detected in response to data remaining in the saved set of data. A problem is detected whenever one of the following events occurs. First, if an entry is found (e.g., an acquisition or suspension) which is more than a user specified age, a problem is detected. Secondly, if the number of entries (unmatched acquisitions or suspensions) is larger than a user specified threshold, a problem is detected. Thirdly, if the total amount of the acquired (and unmatched) resource is larger than a user specified threshold, a problem is detected. The total amount criterion does not apply to task suspensions.

Provided that a problem is detected because one of the previously mentioned events occurs, at step 28, messages are issued providing details of the processing problem according to the user specified control parameters. Then at step 30, operator commands are issued to collect additional problem documentation and tale remedial actions.

The saving, matching, deleting and detecting operations do not occur in strict sequence as the above discussion implies. Acquisitions, releases, suspensions, resumptions, initiations, and terminations occur in the system in a varying pattern. The saved data is constantly changing, with additions and deletions. The detection may be part of the addition processing and/or matching processing, or occur separately at timed intervals. The preferred implementation is to perform the detection processing during the matching since that is when the saved acquisitions/suspensions/initiations are scanned anyway.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for operating a software processing problem detection facility using symmetrical trace data, the method comprising:
examining data in a memory;
saving with a timestamp in a cache a saved set of data for resource acquisitions, task suspensions and the initiations of any processing units;
matching resource releases and saved acquisitions in the saved set of data;
deleting matched acquisitions from the saved set of data;
matching resumptions and suspensions in the saved set of data;
deleting matched suspensions from the saved set of data;
matching processing unit terminations and initiations in the saved set of data;
deleting matched processing unit initiations from the saved set of data; and
detecting a processing problem in response to data remaining in the saved set of data.

2. The method as set forth in claim 1, wherein detecting the problem occurs when any one of the following actions occur, (i) an entry is found that is more than a user specified age, (ii) the number of entries is greater than a user specified threshold and (iii) the total amount of unmatched acquired resource is greater than a user specified threshold.

3. The method as set forth in claim 2, further including issuing messages providing details of the processing problem according to control parameters.

4. The method as set forth in claim 3, further including issuing operator commands to collect additional problem documentation and take remedial actions.
